(19) United States
(12) Patent Application Publication
(10) Pub. No.: US 2026/0094420 A1
(43) Pub. Date: Apr. 2, 2026

(54) COMPUTER-IMPLEMENTED METHOD AND SYSTEM FOR GENERATING A DATASET

(71) Applicant: Robert Bosch GmbH, Stuttgart (DE)

(72) Inventors: Haiwen Huang, Tübingen (DE); Dan Zhang, Leonberg (DE)

(21) Appl. No.: 19/341,596

(22) Filed: Sep. 26, 2025

(30) Foreign Application Priority Data
Oct. 1, 2024 (DE) 10 2024 209 628.8

(51) Int. Cl. G06V 10/774; G06V 10/26; G06V 10/776; G06V 10/82

(52) U.S. Cl. CPC G06V 10/774; G06V 10/26; G06V 10/776; G06V 10/82

(57) ABSTRACT

A computer-implemented method and system for generating a dataset for training and/or validating a first machine learning algorithm. The method includes: providing an input dataset comprising a set of images, wherein objects to be classified are depicted on the images, wherein each image is assigned to at least one class having a class label; for each image, generating a crop of the image, wherein the crop includes the object to be classified; inputting the image and the generated crop into a second machine learning algorithm; generating a label for the crop; providing a dataset including the set of images, wherein each image is assigned the respectively generated label.

### FIELD

The present invention relates to a computer-implemented method and system for generating a dataset for training and/or validating a first machine learning algorithm.

### BACKGROUND INFORMATION

Training data play a central role in machine learning models, in particular in segmentation and object detection. These data often consist of images or videos that are labeled with class names that represent the objects in the image. The quality and precision of these class names are crucial as they significantly influence the performance of the trained model. In segmentation datasets, class names serve as text labels associated with visual information. This allows the model to establish a connection between the visually represented objects and their semantic labels. This connection forms the basis for the subsequent detection and classification of objects in new, unseen data.

In traditional machine learning, these class names are defined in fixed vocabularies. This often results in a limitation of expressive power, particularly in scenarios with open vocabularies, where the model must be capable of identifying new or rare objects that may not occur in the training data. If the class names in the training data are imprecise or too general, this will result in a faulty association between the visual information and the text labels, which in turn will result in a deterioration in model accuracy. This affects not only the training phase, but also the subsequent evaluation of the model, since inaccurate or misleading classification can lead to incorrect results.

During the training process of a segmentation model, a neural network is trained to recognize patterns in the training images and associate them with the corresponding labels, i.e., with the class names. The training process consists of iteratively adapting the model, wherein the differences between the model's predictions and the actual labels are minimized. In this context, a loss function that measures how well the model's predictions match the actual class names is used. However, if inaccurate or inconsistent class names are used, the model may learn incorrect patterns or overgeneralize, leading to lower accuracy in subsequent segmentation or object detection.

Particularly in open-vocabulary segmentation environments, where models must be capable of detecting a wide range of objects with high precision, precise and consistent class names are essential. Multimodal models that can process both visual and textual information open up new possibilities here. These models can access visual information and capture the semantic context of class names by integrating large language models (LLMs) such as GPTs. This allows them to reduce the discrepancy between visual and textual information by not only learning visual features but also improving their understanding of objects and their relationships in the text.

The correct use and definition of class names are therefore not a trivial aspect of data creation but an essential part of the training process of models designed for precise segmentation tasks. Insufficient accuracy of the class names in the training data can result in irreversible errors in the model, directly affecting its ability to perform generalized object detection.

An object of the present invention is to provide a method and system for increasing the quality of class names when generating training data and/or validation data, thereby allowing for better training and testing of segmentation and object detection with an open vocabulary.

This object may be achieved by certain features of the present invention.

### SUMMARY

According to a first aspect of the present invention, this object may be achieved by a computer-implemented method for generating a dataset for training and/or validating a first machine learning algorithm. According to an example embodiment of the present invention, the method comprises the following steps:
providing an input dataset comprising a set of images, wherein objects to be classified are depicted on the images, wherein each image is assigned to at least one class having a class label;
for each image:
   generating a crop of the image, wherein the crop comprises the object to be classified;
   inputting the image and the generated crop into a second machine learning algorithm;
   generating a label for the crop;
providing a dataset comprising the set of images, wherein each image is assigned the respectively generated label.

According to a second aspect of the present invention, this object is achieved by a system for generating a dataset for training and/or validating a first machine learning algorithm.

According to an example embodiment of the present invention, the system comprises a provision unit that is configured to provide an input dataset comprising a set of images, wherein objects to be classified are depicted on the images, wherein each image is assigned to at least one class having a class label.

The system further comprises a calculation unit that is configured, for each image:
a. to generate a crop of the image, wherein the crop comprises the object to be classified;
b. to feed the image and the generated crop into a second machine learning algorithm;
c. to generate a label for the crop.

Furthermore, the system comprises an output unit that is configured to provide a dataset comprising the set of images, wherein each image is assigned the respectively generated label.

Large language models (LLMs) process language by using complex, deep neural networks trained to recognize patterns and dependencies within text. These models are typically built upon transformer architectures, which allows them to capture both local and global dependencies within a text. At the core of this processing are tokens, which represent the smallest linguistic units, such as words or parts of words. Tokenization converts the input text into a sequence of numerical vectors, which are then fed into the model.

During training, LLMs learn to interpret these tokens by analyzing the context in which they occur. This is done by using mechanisms such as self-attention, which allows the model to focus on relevant information throughout the entire sequence, regardless of its position within the text. This context is crucial for the model's ability to capture the meaning of words and phrases, which is in particular relevant when dealing with ambiguities and ambiguous meanings. For class names, this means that an LLM is not only able to process the name as an isolated label, but also to understand the semantic relationships between different class names and their meaning in the given context.

Processing class names with an LLM requires accurately capturing the semantic nuances that underlie those names. An LLM learns this by analyzing large amounts of data in which these class names are used in different contexts. By aggregating this information, the model can derive generalizations that allow it to flexibly apply class names to new objects and situations, even when confronted with terms that did not appear explicitly in the training dataset.

A key aspect of language processing in LLMs is the embedding layer, which transfers the semantic meaning of words and phrases to continuous vector spaces. In these vector spaces, semantically similar words are closer together, allowing the model to learn relationships between different class names. For example, the model could learn that the terms “dog” and “cat” have similar properties in many contexts, while “car” and “airplane” are located in a different semantic space because they represent different object classes. This ability for semantic generalization plays a key role when an LLM is used in segmentation or object detection applications with open vocabularies.

The class names in the data used to train such a model serve as anchors for the semantic understanding of the model. Because LLMs can learn from multimodal data containing both text and image information, they can link the meaning of these class names to visual features. This multimodal capability allows the model to relate class names not only to textual descriptions, but also to visual objects represented by images or videos. This link between linguistic and visual information significantly expands the application scope of LLMs and allows for more accurate object detection and segmentation in real-world scenarios, in particular in open-vocabulary environments.

In the context of the present invention, an input dataset is provided that comprises a set of images. The images may comprise, for example, real images, i.e., photos or x-rays, but also synthetic images, for example from a virtual environment.

Preferably, a machine learning algorithm is used for the method that is different from the machine learning algorithm to be trained. The machine learning algorithm to be trained is therefore referred to as the first machine learning algorithm, while the machine learning algorithm used according to the present invention is referred to as the second machine learning algorithm.

The first machine learning algorithm is trained using the data generated according to the present invention. Its task may, in principle, be of any nature, as long as it uses image data as input. The first machine learning algorithm does not necessarily have to be able to process text.

According to an example embodiment of the present invention, the images from the input dataset are fed into the second machine learning algorithm. Each image is then processed. First, a crop of the image is generated that contains the object to be classified. No additional machine learning algorithm is required for this. This task can also be accomplished, for example, using conventional image processing methods, provided that the parameters required for cropping are provided. The resulting crop and the overall image, which is used as context for the crop in further processing, are then input into the second machine learning algorithm.

The second machine learning algorithm will generate a new label based on the input and assign it to the crop. This process is repeated for all of the images in the input dataset, so that each crop of each image is assigned a new label. By machine processing of the image data, a certain consistency is achieved in the assignment of labels and the associated class membership of the image data, thereby improving the quality of the training data for the first machine learning algorithm. At the same time, label generation is flexible, so that it can generate labels suited to the input image data. The present invention thus achieves its object.

In one example embodiment of the present invention, the second machine learning algorithm comprises a visual language model.

A visual language model is a machine learning algorithm that accepts both language and graphical data, in particular images or image data, as input and can process them together. Such models are also called multimodal models.

In one example embodiment of the present invention, the command to output the label is written in natural language.

Furthermore, a natural language input, referred to as a “prompt,” is input into the machine learning algorithm. The prompt asks the machine learning algorithm to generate a label for the crop of the image. The prompt may further contain further instructions;

for example, it may tell the second machine learning algorithm to pretend to be an expert in image classification or class naming. Specifically, a prompt might look like this:

“Imagine you are an expert and you are asked to rename a segment in an image in order to improve the quality of the name. The first image is the cropped segment of interest, originally labeled [placeholder]. The second image is the context image, which uses a red bounding box to show where the crop is located in the image.

Your goal is to identify a name that is related to the original name “[placeholder],” such as a synonym or subcategory, that best matches common linguistic usage to describe this crop. Briefly explain your reasoning and end your answer with A: new name, where new name is the name you chose. If the segment is incorrectly named, or if a new name cannot be found, answer ‘A:NA’.”

Large language models are receptive to concepts that emerge from a text. Differences in word choice or formulation play a minor role in the processing of the prompt. Prompts that are worded differently but have a similar meaning may therefore also be used. The [placeholder] specified in the prompt may be filled with the class label originally assigned to the image or image crop.

In one example embodiment of the present invention, the label is selected from a list of synonyms or subcategories of the first label.

The list may be provided to the second machine learning algorithm and may, in particular, be specified by a user or suggested by another machine learning algorithm. The list can be used to limit the number of possible class labels to a defined size. This can in particular prevent each image from being given its own label.

In one example embodiment of the present invention, the method further comprises:
inputting each image into a third machine learning algorithm together with a command to verify the label and
verifying the generated label.

In particular, the command to verify the label may be a natural language command, i.e., a prompt. For example, the prompt might be:

“Imagine you are an expert and you are asked to rename a segment in an image in order to improve the quality of the name. Another expert believes this segment should be called [generated label]. The original name is [placeholder]. Which name do you think is better, the original name or the new name?”

The label generated by the second machine learning algorithm is used for [generated label] and [placeholder] is replaced by the class label specified in the input dataset.

Furthermore, the third machine learning algorithm may be a further machine learning algorithm that receives the output from the second machine learning algorithm. In particular, the first and second machine learning algorithm may be configured to communicate with one another as what are referred to as agents, such that the output from the second machine learning algorithm is used directly as input for the third machine learning algorithm.

Alternatively, a model may be used that can use two independent threads, with one thread performing the task of the second machine learning algorithm and another thread performing the task of the third machine learning algorithm.

In one example embodiment of the present invention, a further label is generated if the output from the third machine learning algorithm indicates that the previously generated label is not verified.

If the third machine learning algorithm is unable to verify the generated label, i.e., it believes that the generated label is not suitable for the crop, then a further label is generated. This may be done by the second machine learning algorithm by giving it a new command to generate a label. The further label may alternatively be generated by the third machine learning algorithm.

Theoretically, this principle may be continued until the second machine learning algorithm and the third machine learning algorithm have agreed on a label. In practice, however, the process may also be shortened by using the second or xth label generated in case of disagreement.

In one example embodiment of the present invention, the verifying comprises a comparison of the generated label with the further label by the third machine learning algorithm.

The third machine learning algorithm can verify the generated label by checking how well the label linguistically matches what it reads from the image crop. This aspect of verification is effected by computations internal to the third machine learning algorithm, wherein an albeit complex formula is used, the result of which is the output for the verification result.

In one example embodiment of the present invention, the label is used to generate a text-based natural language justification for the label, wherein the label is verified using the justification.

Verification by the third machine learning algorithm solely on the basis of the label may lead to inaccurate results because the data volume used as input to the third machine learning algorithm is limited. By adding a justification, the third machine learning algorithm can also review these data and thereby obtain a better classification for the label generated by the second machine learning algorithm. This means that the volume of input data increases, which can ultimately result in a more precise output.

In one example embodiment of the present invention, the first machine learning algorithm comprises an algorithm for recognizing traffic signs, the integrity of road surfaces and lanes, pedestrians and/or vehicles.

In a further aspect, the present invention relates to a computer program having program code in order to perform a method as described above when the computer program is executed on a computer.

In a further aspect, the present invention relates to a computer-readable data carrier having program code of a computer program in order to perform a method as described above when the computer program is executed on a computer.

In a further aspect, the present invention relates to a system for generating a dataset for training and/or validating a first machine learning algorithm, wherein the system is designed to carry out a method as described above.

In summary, the present invention provides a method for generating a dataset for training and/or validating a first machine learning algorithm, a computer program, a computer-readable data carrier having program code, and a system for generating a dataset for training and/or validating a first machine learning algorithm.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

### BRIEF DESCRIPTION OF THE DRAWINGS

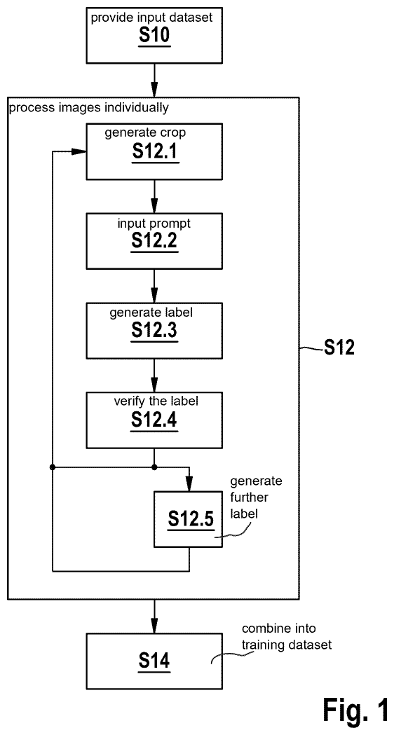

FIG. 1 schematically shows the sequence of the method according to the present invention according to one example embodiment.

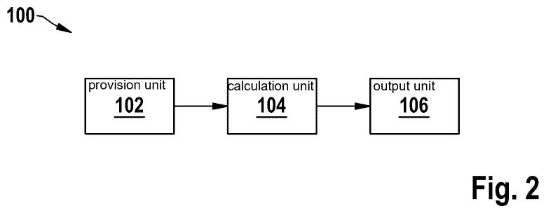

FIG. 2 is a diagram of the system according to the present invention according to one example embodiment.

In the figures, identical reference signs denote identical or functionally identical elements, parts or components, unless stated otherwise.

### DETAILED DESCRIPTION OF EXAMPLE EMBODIMENTS

FIG. 1 schematically shows the sequence of the method according to one embodiment. The method can be regarded as comprising two nested processes, an outer process and an inner process.

The outer process begins with step S10, in which an input dataset is provided. For example, if the first machine learning algorithm is to be used to monitor the surrounding traffic and the input data for this machine learning algorithm comprise camera images, many images of traffic situations can be used as the input dataset.

The images show one or more objects, which is indicated in the input dataset using class labels for the individual images or the objects depicted therein.

The images are then processed individually in step S12 by the second and third machine learning algorithm. This step S12 comprises a plurality of substeps that represent the internal process.

Once all of the images have been processed in step S12, in step S14 the images, the crops generated therefrom, and the labels generated for the crops are combined into a training dataset and made available for training the first machine learning algorithm.

The following explains the inner process performed by the second and third machine learning algorithm in this embodiment. This process is performed for each image in the input dataset, so the set of images provided for training the first machine learning algorithm is not diminished.

In step S12.1, a crop is first generated from each image, which crop shows the object and as little as possible of background material that is irrelevant or even disruptive for generating the label. For example, if the image shows a traffic situation and the first machine learning algorithm is to be trained to recognize traffic signs from camera images, the regions of the image that do not show a traffic sign can be removed. Such images usually show part of the sky, part of the road, and the surroundings of the road, which are not needed or at most only contextually needed in order to find a suitable label.

In step S12.2, the generated crop and image, as well as a natural language command, referred to as a “prompt,” are input into the second machine learning algorithm. The prompt contains instructions for the second machine learning algorithm, which provides the context for the general task of generating labels for image crops and contains a specific request to generate a label for the input crop.

The context is important for the second machine learning algorithm because it determines what type of label is generated. For example, if the crop shows a traffic sign, the context may indicate that the second machine learning algorithm should output the type of traffic sign as a label.

In step S12.3, the label is generated according to the commands from the prompt. This label could, in principle, be used for the training set or for training the first machine learning algorithm. However, experiments have shown that the labels become more precise when a third machine learning algorithm checks the generated label.

For verification (step 12.4), the original image, the generated crop, the original label, the generated label for the crop, and, optionally, a justification produced by the second machine learning algorithm for that generated label are input into the third machine learning algorithm. Said third machine learning algorithm performs the verification, for example by comparing the original label with the generated label and evaluating it semantically. The graphical information from the crop, the context from the original image, and the justification may be taken into account.

If the third machine learning algorithm verifies the generated label, i.e., considers it better than the original label, then the internal process starts again with the next image. If the generated label cannot be verified, a further label is generated in step S12.5. Optionally, this further label can also be verified, wherein the machine learning algorithm that did not generate the further label preferably performs the verification.

FIG. 2 shows a system 100 for generating a dataset for training and/or validating a first machine learning algorithm.

The system comprises a provision unit 102 that is configured to provide an input dataset S10 comprising a set of images, wherein objects to be classified are depicted on the images, wherein each image is assigned to at least one class having a class label.

The system further comprises a calculation unit 104 that is configured, for each image S12:
d. to generate a crop S12.1 of the image, wherein the crop comprises the object to be classified;
e. to feed the image and the generated crop into a second machine learning algorithm S12.2;
f. to create a label for the crop.

Furthermore, the system comprises an output unit (106) that is configured to provide a dataset (S14) comprising the set of images, wherein each image is assigned the respectively generated label.

1-12. (canceled)

13. A computer-implemented method for generating a dataset for training and/or validating a first machine learning algorithm, wherein the method comprises the following steps:
providing an input dataset including a set of images, wherein objects to be classified are depicted in the images, wherein each image is assigned to at least one class having a class label;
for each image:
generating a crop of the image, wherein the crop includes the object to be classified,
inputting the image and the generated crop into a second machine learning algorithm, and
generating a respective label for the crop;
providing a dataset includes the set of images, wherein each image is assigned the respectively generated label.

14. The computer-implemented method according to claim 13, wherein the second machine learning algorithm includes a visual language model.

15. The computer-implemented method according to claim 13, wherein a command for outputting the respective label is written in natural language.

16. The computer-implemented method according to claim 13, wherein the respective label is selected from a list of synonyms or subcategories of the first label.

17. The computer-implemented method according to claim 13, wherein the method further comprises:
inputting each image into a third machine learning algorithm together with a command to verify the respective label, and
verifying the respective label.

18. The computer-implemented method according to claim 17, wherein a further label is generated when an output of the third machine learning algorithm indicates that the respective label is not verified, wherein the further label replaces the respective label.

19. The computer-implemented method according to claim 17, wherein the verifying includes a comparison of the generated respective label with the further label by the third machine learning algorithm.

20. The computer-implemented method according to claim 18, wherein the respective label is used to generate a text-based natural language justification for the respective label, wherein the respective label is verified using the justification.

21. The computer-implemented method according to claim 13, wherein the first machine learning algorithm includes an algorithm for recognizing traffic signs, and/or an integrity of road surfaces and lanes, and/or pedestrians, and/or vehicles.

22. A non-transitory computer-readable data carrier on which is stored program code of a computer program for generating a dataset for training and/or validating a first machine learning algorithm, the program code, when executed by a computer, causing the computer to perform the following steps:
providing an input dataset including a set of images, wherein objects to be classified are depicted in the images, wherein each image is assigned to at least one class having a class label;
for each image:
generating a crop of the image, wherein the crop includes the object to be classified,
inputting the image and the generated crop into a second machine learning algorithm, and
generating a respective label for the crop;
providing a dataset includes the set of images, wherein each image is assigned the respectively generated label.

23. A system configured to generate a dataset for training and/or validating a first machine learning algorithm, the system comprising:
a provision unit configured to provide an input dataset including a set of images, wherein objects to be classified are depicted in the images, wherein each image is assigned to at least one class having a class label;
a calculation unit configured to, for each image:
generate a crop of the image, wherein the crop includes the object to be classified,
feed the image and the generated crop into a second machine learning algorith, and
generate a respective label for the crop; and
an output unit configured to provide a dataset including the set of images, wherein each image is assigned the respectively generated label.
